(19) United States
(12) Patent Application Publication
(10) Pub. No.: US 2012/0171471 A1
(43) Pub. Date: Jul. 5, 2012

(54) PLASTIC MEMBER AND MANUFACTURING METHOD THEREOF

(76) Inventors: Yau-Hung CHIOU, Taipei City (TW); Yu-To CHAO, Taipei City (TW); Hsueh-Tsu CHANG, Taipei City (TW)

(21) Appl. No.: 13/053,815

(22) Filed: Mar. 22, 2011

(30) Foreign Application Priority Data
Dec. 30, 2010 (TW) 099147031

(51) Int. Cl. B32B 15/04; B32B 5/00; H05H 1/24; B32B 9/00

(52) U.S. Cl. 428/336; 428/698; 428/457; 427/535

(57) ABSTRACT

The present invention discloses a plastic member and a manufacturing method thereof, the manufacturing method comprises the steps of: providing a plastic substrate; bombarding the plastic substrate by plasma to break at least one carbon-hydrogen bond or at least one carbon-series bond of the plastic substrate, and generating at least one carbon dangling bond on the surface of the plastic substrate; depositing at least one metal atom to chemically react the metal atom with the carbon dangling bond and generate a bonding between the carbon and the metal.

### BACKGROUND OF THE INVENTION

1. Field of the Invention

The present invention relates to a plastic member and a surface modification method thereof; and more particularly to a plastic member having metal carbide and a manufacturing method thereof.

2. Brief Description of the Related Art

The casings of existing mobile phones, laptops and PDAs are mostly made of plastics, and in order to improve the appearance or to shield EMI, the plastic members are generally coated with a metal layer. The metal layer is mostly applied using electrochemical plating method or polymer primer to adhere to the plastic casings.

However, the plating solution used in electrochemical plating method contains toxic substances and causes environmental pollution and high cost in the blowdown process; the polymer primer has the same situation: high cost, high environmental pollution risk and complex manufacturing process. Therefore, it is an important issue to provide a low pollution, single-step manufacturing method for metal adhesion on plastic members.

### SUMMARY OF THE INVENTION

In order to overcome the deficiencies of the prior art, a primary object of the present invention is to provide a plastic member and its manufacturing method thereof to improve the high cost and high pollution problems of the prior art.

With the above object in mind, the present invention provides a plastic member having a plastic substrate and a metal carbide layer. The metal carbide layer is disposed on the plastic substrate and comprises at least one metal atom that is chemically bonded with at least one carbon atom of the plastic substrate.

Wherein, the plastic substrate has a heat deformation temperature higher than 150° C.

Wherein, the metal carbide layer has a thickness within the range of 1-5 nanometers.

Wherein, the plastic member further comprises a metal layer disposed on the metal carbide layer.

With the above object in mind, the present invention further provides a plastic member manufacturing method comprising the steps of:
providing a plastic substrate;
bombarding the plastic substrate by plasma to break at least one carbon-hydrogen bond or at least one carbon-series bond of the plastic substrate, thereby generating at least one carbon dangling bond on the surface of the plastic substrate; and
depositing at least one metal atom by vacuum coating method; the metal atom then chemically reacting with the carbon dangling bond and thereby forming a bonding thereof.

Wherein, the plastic substrate has a heat deformation temperature higher than 150° C.

Wherein, the working pressure of plasma bombarding or vacuum plating falls within the range of 10⁻²-10⁻⁴ Pa.

Wherein, the plastic member manufacturing method further comprises the step of heating the plastic substrate in a corresponding vacuum level to a temperature of 0-10° C. lower than the heat deformation temperature of the plastic substrate.

Wherein, the metal carbide layer has a thickness within the range of 1-5 nanometers.

Wherein, the plastic member manufacturing method further comprises a step of depositing a metal layer on top of the metal carbide layer with vacuum coating method.

As the foregoing, the plastic member and its manufacturing method according to the present invention have the following advantages:
(1) The plastic member and its manufacturing method thereof can process the surface processing of the plastic substrate by plasma bombarding and then further deposit a metal carbide layer between the plastic substrate and the metal layer to solve the problem of the poor adhesion of the conventional metal layer.
(2) The plastic member and its manufacturing method thereof can deposit the metal carbide layer and the metal layer by using a single-step plasma process to solve the problem of high cost and high pollution of the prior art.

### BRIEF DESCRIPTION OF THE INVENTION

The detail structure, the applied principle, the function and the effectiveness of the present invention can be more fully understood with reference to the following description and accompanying drawings, in which:

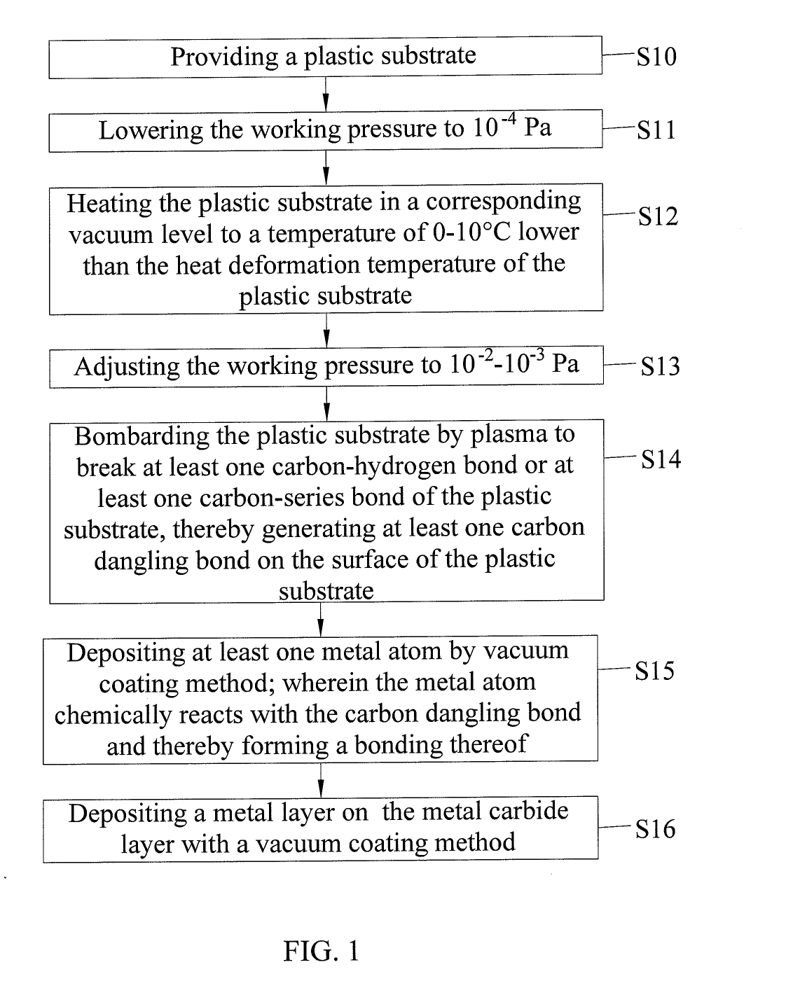

FIG. 1 is a flow chart illustrating the manufacturing method of the plastic member according to the present invention;

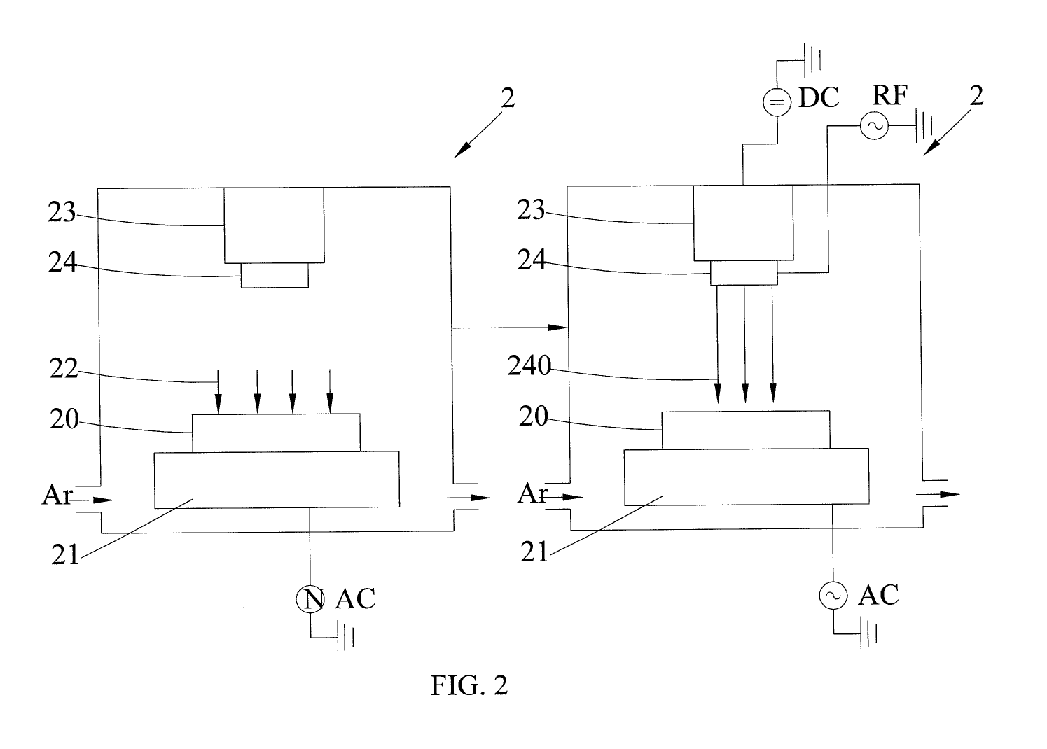

FIG. 2 is a schematic representation of the manufacturing method of the plastic member according to the present invention;

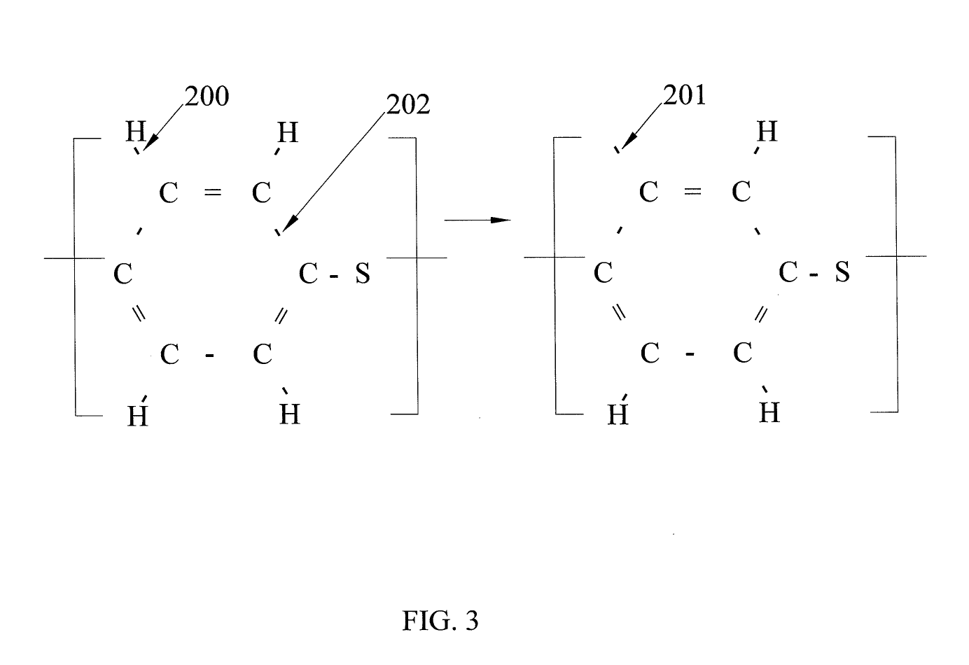

FIG. 3 is a schematic representation of the plastic substrate's broken carbon-hydrogen bonds and the metal atom replacing the hydrogen atom according to the present invention; and

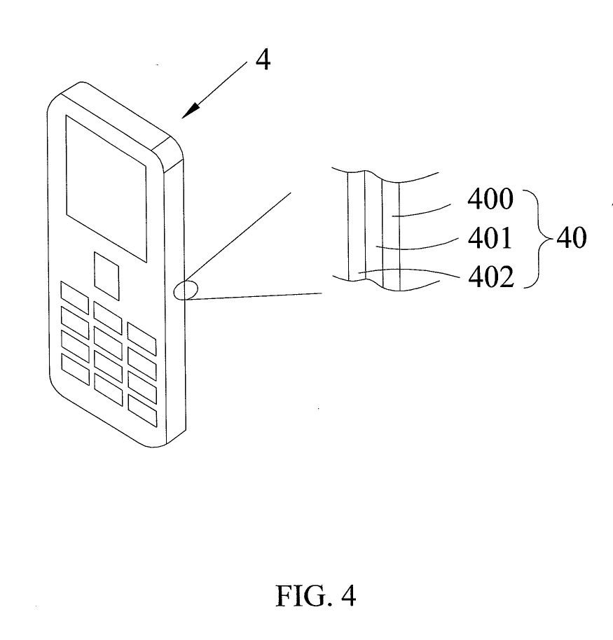

FIG. 4 is a schematic representation of an embodiment of the plastic member according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

With reference to FIG. 1, the flow chart illustrates the manufacturing method of the plastic member according to the present invention. The plastic member manufacturing method comprises steps of:
S10: providing a plastic substrate;
S11: lowering the working pressure to 10⁻⁴ Pa;
S12: heating the plastic substrate in a corresponding vacuum level to a temperature of 0-10° C. lower than the heat deformation temperature of the plastic substrate;
S13: adjusting the working pressure to 10⁻²-10⁻³ Pa;
S14: bombarding the plastic substrate by plasma to break at least one carbon-hydrogen bond or at least one carbon-series bond of the plastic substrate, thereby generating at least one carbon dangling bond on the surface of the plastic substrate;
S15: depositing at least one metal atom by a vacuum plating method, and the metal atom then chemically reacting with the carbon dangling bond and thereby forming a bonding thereof; and
S16: depositing a metal layer on top of the metal carbide layer with a vacuum plating method.

Wherein, the plastic substrate has a heat deformation temperature higher than 150° C. and the metal carbide layer has a thickness within the range of 1-5 nanometers.

Please refer to FIG. 2, which illustrates a schematic diagram of the manufacturing method of the plastic member according to the present invention. As shown on the left half of FIG. 2, a plastic substrate 20 is disposed on a stage 21 inside a sputtering system 2. The method comprises the steps of: lowering the working pressure to at least 10⁻⁴ Pa (backing pressure), and then guiding in the plasma or ionizable gas such as Ar; adjusting the working pressure to 10⁻²-10⁻³ Pa and then inputting an AC or DC voltage of 35-65 V (100% power) to convert Ar gas into plasma 22 and therefrom bombarding the plastic substrate 20 for 5-15 minutes. Please refer to FIG. 3, which illustrates the plastic substrate's broken carbon-hydrogen bonds and the metal atom replacing the hydrogen atom according to the present invention. As shown in this figure, a carbon-hydrogen bond 200 or carbon-series bond 202 of the bombarded plastic substrate 20 is broken and at least one carbon dangling bond 201 is generated.

With reference to the right half of the FIG. 2, the reactive sputtering is performed, by inputting an AC or DC voltage of 125-175 V (85% power) such as a radio frequency (RF) to a sputtering gun 23, and lowering the bias power of the plastic substrate to around 15% to generate plasma for sputtering a target material 24. Wherein, the target material 24 is a metal material such as Fe, Cr, Zn, W, or Ti. The target material 24 is then sputtered by the plasma to generate at least one metal atom 240 and moved towards the plastic substrate 20 and then chemically reacted with the carbon dangling bond 201 of the plastic substrate 20 to form a bonding thereof; wherein, a metal carbide MₓC_{y} such as Fe₃C is generated.

The electric source inputted to the target material 24 falls within a range of 5V-300V and has a power of around 10%-85%. The bias power of the plastic substrate 20 is around 15%-90% and within a range of 0V-150V. The foregoing settings are in accordance with different plastic members and the present invention does not intend to make limits thereof.

After the metal carbide layer is reactively sputtered, the reactive sputtering process can further deposit a metal layer on top of the metal carbide layer to assist with EMI Shielding, RFI Shielding or Anti-ESD features, or to decorate the plastic substrate coordinating with a mask. Compared with the prior art having no metal carbide layer, the present invention has increased the electrical resistance value from 1-5 ohm to 100-500 ohm owing to the application of the metal carbide layer, and the increased electrical resistance value is still smaller than the oxidized metal. Moreover, the present invention increases the metal layer's adhesion to the plastic substrate to 5B (prior art is of around 3B-5B) under the Cross Hatch Test (ASTM D3359, interval of 1 mm and X-Y each 10 units). Therefore, the present invention effectively increases the adhesive force of metal decoration layer or metal EMI shielding layer towards the plastic members such as casing bodies.

With reference to FIG. 4 for an embodiment of the plastic member according to the present invention, the plastic member 40 of the present invention can be used as an outer casing of a mobile phone 4. The plastic member 40 comprises a plastic substrate 400, a metal carbide layer 401 and a metal layer 402. The metal carbide layer 401 is disposed on the plastic substrate 400, and at least one metal atom of the metal carbide layer 401 is bonded with at least one carbon atom of the plastic substrate 400. The metal layer 402 is disposed on the metal carbide layer 401.

The plastic substrate 400 has a heat deformation temperature higher than 150° C., and the metal carbide layer 401 has a thickness within the range of 1-5 nanometers. Further, the metal atoms of the metal carbide layer 401 and the metal layer 402 could be metal materials such as Fe, Cr, Zn, W, or Ti.

As described above, the plastic member and the manufacturing method thereof according to the present invention are capable of processing the surface of the plastic substrate by plasma bombarding and then further depositing the metal carbide layer between the plastic substrate and the metal layer, solving the problem of metal layer's poor adhesion of the prior art; and also capable of depositing the metal carbide layer and the metal layer on the plastic substrate by using a single plasma process, and solving the high cost and high pollution problem of the prior art.

While the invention has been described with reference to a preferred embodiment thereof, it is to be understood that modifications or variations may be easily made without departing from the spirit of this invention, which is defined in the appended claims.

What is claimed is:

1. A plastic member comprising:
a plastic substrate; and
a metal carbide layer, disposed on the plastic substrate and comprising at least one metal atom that is bonded with at least one carbon atom of the plastic substrate.

2. The plastic member as defined in claim 1, wherein the plastic substrate has a heat deformation temperature higher than 150° C.

3. The plastic member as defined in claim 1, wherein the metal carbide layer has a thickness within the range of 1-5 nanometers.

4. The plastic member as defined in claim 1, wherein the plastic member further comprises a metal layer disposed on the metal carbide layer.

5. A plastic member manufacturing method comprising the steps of:
providing a plastic substrate;
bombarding the plastic substrate by plasma to break at least one carbon-hydrogen bond or at least one carbon-series bond of the plastic substrate, thereby generating at least one carbon dangling bond on the surface of the plastic substrate; and
depositing at least one metal atom by vacuum coating method, and the metal atom then chemically bonding with the carbon dangling bond.

6. The plastic member manufacturing method as defined in claim 5, wherein he plastic substrate has a heat deformation temperature higher than 150° C.

7. The plastic member manufacturing method as defined in claim 5, wherein the working pressure of plasma bombarding or vacuum coating method falls within the range of 10⁻²-10⁻⁴ Pa.

8. The plastic member manufacturing method as defined in claim 7 further comprises the step of heating the plastic substrate in a corresponding vacuum level to a temperature of 0-10° C. lower than the heat deformation temperature of the plastic substrate.

9. The plastic member manufacturing method as defined in claim 5, wherein the metal carbide layer has a thickness within the range of 1-5 nanometers.

10. The plastic member manufacturing method as defined in claim 5 further comprising a step of:
depositing a metal layer on the metal carbide layer by a vacuum coating method.
